(19) United States
(12) Patent Application Publication
(10) Pub. No.: US 2013/0274165 A1
(43) Pub. Date: Oct. 17, 2013

(54) ACIDIC MICROEMULSION STRIPPING FORMULATIONS

(71) Applicants: Caroline Woelfle, Midland, MI (US); Christopher J. Tucker, Midland, MI (US)

(72) Inventors: Caroline Woelfle, Midland, MI (US); Christopher J. Tucker, Midland, MI (US)

(73) Assignee: DOW GLOBAL TECHNOLOGIES LLC, Midland, MI (US)

(21) Appl. No.: 13/988,618

(22) PCT Filed: Dec. 12, 2011
(86) PCT No.: PCT/US11/64426

§ 371 Date: May 21, 2013

Related U.S. Application Data
(60) Provisional application No. 61/424,506, filed on Dec. 17, 2010.

(51) Int. Cl. C09D 9/04

(52) U.S. Cl. CPC C09D 9/04
USPC 510/206

(57) ABSTRACT

Described are stripper compositions, comprising an acidic microemulsion, said microemulsion comprising C₁₋₄ carboxylic acid, a poorly water soluble solvent, a salt, a surfactant, and water, wherein the stripper composition comprises less than 40% of methyl benzoate, cyclic ketone, or a mixture thereof, and wherein the stripper composition is capable of removing a removable coating.

### FIELD

The present invention relates to compositions for removing removable coatings, particularly to compositions for removing isocyanate-free removable coatings.

### BACKGROUND

Market demand for isocyanate-free removable coatings, such as for automotive, flooring, and other applications has driven exciting developments in the past few years, for example, latexes and carbamate based removable coatings, such as are described in U.S. Ser. No. 61/355,266, filed Jun. 16, 2010, the entirety of which is incorporated by reference herein.

However, one unmet need relates to improved compositions for removing these isocyanate-free removable coatings efficiently, such compositions being referred to as “stripping formulations” or “strippers.” Strippers generally swell the polymer to be removed, which, when coupled with the application of a mechanical force, act to remove the removable coating. Additionally, strippers used for removing regular metal crosslinked floor polishes usually contain an amine base which disrupts the metal crosslinks present in the removable coating, and thus enhance the efficiency of the floor stripper. As may be appreciated, strippers are appreciated in the industry in proportion to their ease of removability. Moreover, it maximizes economic efficiency if the stripper accomplishes its purpose with as little active ingredients as possible.

Therefore, what is needed are compositions for removing isocyanate-free removable coatings with relative ease and efficiency.

### DESCRIPTION

In one embodiment, the present invention provides stripper compositions, comprising an acidic microemulsion, said microemulsion comprising C₁₋₄ carboxylic acid, a poorly water soluble solvent, a salt, a surfactant, and water, wherein the stripper composition comprises less than 40% of methyl benzoate, cyclic ketone, or a mixture thereof, and wherein the stripper composition is capable of removing a removable coating. Preferably, the stripper composition comprises less than 35%, preferably less than 30%, preferably less than 26%, of methyl benzoate, cyclic ketone, or a mixture thereof.

“Stripper composition” refers to a composition that is capable of removing a removable coating. A composition is “capable of removing a removable coating” when after application, and scrubbing of the floor polish, the naked tile is clearly visible, and free of residual floor polish.

“Removable coating” refers to a covering that is applied to a floor substrate to enhance its appearance, scratch resistance, resistance to stains and liquids, etc. It is understood that ultra-durable compositions, such as polyurethanes and epoxies, are not intended to be embraced by the term “removable coating” for purposes of this specification. In one embodiment, the removable coating is a carbamate based removable coating. In one embodiment, the removable coating is a latex removable coating. In one embodiment, the removable coating is one typically used in removable coating floors.

“Microemulsion” refers to infinitely stable systems which do not phase separate, unless a change in factors such as composition, temperature or pressure is applied. Unlike emulsions which require high shear to form, microemulsions form spontaneously providing the right composition is attained. The size of the droplets formed within a microemulsion is usually smaller than 100 nm, while droplet sizes within an emulsion are usually larger than 1000 nm. As a result, emulsions are turbid, while microemulsions are single phase transparent systems, which are either completely clear, or have a slightly bluish color.

Whereas emulsions require high shear to be formed, in contrast, microemulsions are systems which form instantaneously upon mixing of the components. Simple shaking to mix the components together is enough to form a microemulsion, if the right composition is used. Methods of making microemulsions are well-known, and employ the use of a nonionic surfactant or an ionic surfactant, as well as mixtures of these. Systems based on nonionic surfactants are temperature sensitive, while systems based on ionic surfactants usually require a salt, and a co-solvent to form. Microemulsions can exist in equilibrium with an oil phase, a water phase, or both. Depending on the composition a single phase system can be obtain, which is highly desirable for commercial floor stripping applications.

“Poorly water soluble solvent” means less than a 0.1% water solubility. In a preferred embodiment, the poorly water soluble solvent is methyl benzoate (solubility around 0.019 g/100 mL), a cyclic ketone (preferably cyclohexanone), or a mixture thereof. In one embodiment, the poorly water soluble solvent is methyl benzoate. In this embodiment, the methyl benzoate is present in the microemulsion in range from greater than 5%, greater than 10%, about 15%, less than 20%, or less than 25%. In one embodiment, the poorly water soluble solvent is cyclohexanone. In this embodiment, the cyclohexanone is present in the microemulsion in a range from greater than 15%, greater than 20%, about 25%, less than 30%, or less than 35%.

In one embodiment, the salt is an alkali halide, preferably lithium chloride. The salt is present in the microemulsion in a range from greater than 0.1%, greater than 0.24%, less than 0.8%, or less than 1%.

In one embodiment, the surfactant is a nonionic surfactant or an ionic surfactant.

In one embodiment, the surfactant is linear alkylbenzene sulfonate (LAS). In this embodiment, the surfactant is present in the microemulsion in a range from greater than 3%, greater than 5%, about 7%, less than 9%, or less than 15%.

In one embodiment, the water is present in the microemulsion in a range from about at least 45% water, preferably at least 49% water, about 50%, less than 58%, or less than 65%.

In one embodiment, the C₁₋₄ carboxylic acid of the microemulsion is formic acid. In this embodiment, the formic acid is preferably present in an amount from 1% to 5% of the microemulsion. Optionally, the microemulsion further comprises a co-solvent. To form a microemulsion with an anionic surfactant, a co-solvent is practically always needed. For microemulsions containing a nonionic surfactant, however, in most cases, no co-solvent is needed. Usually it is preferable to avoid nonionic surfactants for floor strippers because the system becomes then temperature sensitive because of the influence of the temperature on the solubility of the surfactant. Formulations containing a nonionic surfactant which are stable in a certain range of temperature can however be achieved, and mixture of anionic-nonionic surfactants can be used as well. When present, the microemulsion contains at least 5%, preferably at least 10%, more preferably at least 15% co-solvent. A preferred co-solvent is butyl carbitol.

In one embodiment, the microemulsion contains no propylene glycol.

As the microemulsion is a single phase, it can be appreciated that with careful selection of components, some dilutions of the microemulsion will result in embodiments wherein the diluted stripper composition is in a single phase. Particularly, this is true where the poorly soluble solvent is cyclohexanone. Similarly, in some embodiments, the stripper composition is clear, or a translucent blue.

In use, the stripper composition is applied to a coated substrate, allowed to sit for a time, then the substrate is agitated, such as by brushing or scrubbing, to remove the coating.

### EXAMPLES

The following examples are for illustrative purposes only and are not intended to limit the scope of the present invention. All percentages are by weight unless otherwise specified.

### Example 1

Examples of microemulsions of the present invention suitable for stripping compositions are listed in TABLE 1:

TABLE 1

| | Sample 1 | Sample 2 | Sample 3 |
|---|---|---|---|
| Methyl Benzoate | 15% | — | — |
| Cyclohexanone | — | 25% | 24% |
| Lithium Chloride | 0.25% | 0.25% | 0.25% |
| Formic Acid | 3% | 3% | 3% |
| (LAS) | 7.2% | 7.2% | 7.2% |
| Butyl carbitol | 10% | 15% | 15% |
| Water | 64.55% | 49.55% | 50.1% |

For microemulsions, the order of addition of the components or methods of mixing are not critical, since they do not require shear to form. In this example, components are mixed together in a vial with shaking.

### Example 2

A comparative microemulsion with a highly water soluble solvent instead of a poorly water soluble solvent is listed in TABLE 2:

TABLE 2

| | Comparative Sample A |
|---|---|
| Propylene Glycol | 25% |
| Lithium Chloride | 0.25% |
| Formic Acid | 3% |
| (LAS) | 7.2% |
| Butyl carbitol | 15% |
| Water | 56.75% |

Comparative Sample A is prepared substantially according to the protocol of Example 1.

### Example 3

To test the efficacy of stripping compositions of the present invention, carbamate-based removable coating formulations were prepared and are listed in TABLE 3:

TABLE 3

| | Coating X | Coating Y | Coating Z |
|---|---|---|---|
| UNOXOL Dialdehyde | 7.46 | 6.58 | 4.95 |
| ADI Trimer-2- | 86.71 | — | — |
| hydroxyethylcarbamate | | | |
| DESMOPHEN A 365- | — | 70.35 | — |
| carbamate | | | |
| PAPI 20 Polycarbamate | — | — | 72.74 |
| Dodecylbenzene | 0.56 (50% | 23.07 (1% | 5.53 (25% |
| sulfonic acid | solution | solution | solution |
| | in MEK) | in MEK) | in MEK) |
| MEK | 4.33 | — | 16.00 |
| BYK 306 surfactant | 0.93 | — | 0.78 |

Carbamate materials were prepared by known methods. The carbamate material, solvent and UNOXOL Dialdehyde were placed into a 20 mL glass vial, capped and mixed using a high speed vortex mixer for 60 seconds at 3500 rpm until all a homogeneous solution was observed. To the mixture was added the dodecylbenzenesulfonic acid catalyst solution. The vial was capped and mixed on a vortex mixer for 30 seconds at 3500 rpm. This final mixture was immediately used for coating experiments.

Coating W is comprised of 99.31% Latex E-3242 adhesion containing latex (not cross-linked) available from The Dow Chemical Co and 0.69% UNOXOL Dialdehyde. The latex material and UNOXOL Dialdehyde were placed into a 20 mL glass vial, capped and mixed using a high speed vortex mixer for 120 seconds at 3500 rpm or until all the air bubbles were removed from the solution. This mixture was immediately used for the coating experiments.

### Coating of Tiles

The tile substrate, 12 inch×12 inch black tiles were coated by using a draw down bar. A #5 wire-wound draw down bar was placed at the top of the tile and a sufficient quantity of material to be tested, ˜10 g, was placed behind the bar. The bar was drawn over the tile by hand using a steady slow motion and was pulled to the bottom of the tile. A uniform coating resulted. This coating was allowed to dry for at least 7 days before testing. The dry coating thickness ranged between 2.2 mils to 2.5 mils The tiles were cut into smaller pieces for testing.

### Removal of Coatings

One of each of the sets of coated tiles from above was soaked for thirty minutes with the stripping compositions listed above, including FREEDOM® brand commercial stripper (Diversey Inc. Sturtevant, Wis. 53177 USA). FREEDOM® floor stripper contains multiple reagents to swell the polymer film including: solvents, such as diethylene glycol phenyl ether, and ethylene glycol phenyl ether, amines such as monoethanolamine, and surfactants such as sodium xylene sulfonate. The commercial floor stripper was used undiluted since the microemulsions were not diluted (but generally it is expected that commercially appropriate dilutions could be readily determined (cyclohexanone microemulsions of 1 to 4, 1 to 8, 1 to 12, 1 to 25 stayed clear and single phase)). The soaked tiles were then scrubbed for one minute at a rate of 50 strokes/min Results are summarized in TABLE 4:

TABLE 4

| | Coating W | Coating X | Coating Y | Coating Z |
|---|---|---|---|---|
| Sample 1 | 30% | 90% | 97% | 75% |
| Sample 2 | 65% | 100% | 75% | 80% |
| Sample 3 | 70% | 100% | 45% | 80% |
| Comparative | 0% | 0% | 0% | 0% |
| Sample A | | | | |
| Comparative | 30% | 20% | 0% | 5% |
| FREEDOM | | | | |
| stripper | | | | |

Coating W, based on a non-crosslinked latex, was better removed by Inventive Sample 2 and Sample 3 than the competitive example.

Coating X contains isocyanate, however, the reacted product is a 1K system which can be applied without exposure to isocyanate. Inventive Sample 2 and Sample 3 provided complete stripping of coating X. Sample 1 provided a 90% removal of the coating. The competitive floor stripper formulation provided a 20% removal of the coating. Sample A based on propylene glycol did not provide any removability of the coating, which shows that the acid combined with a water soluble solvent is not enough to remove the coatings.

Coating Y which is a carbamate based coating, is almost entirely removed by inventive Sample 2 and Sample 3, while there was no removability observed when using the competitive floor stripper formulation. Comparative Sample A, based on propylene glycol, did not provide any removability of the coating, which shows that the acid combined with a water soluble solvent is not enough to remove the coatings.

Inventive Sample 1, Sample 2, and Sample 3 all provided better removability than the competitive example for removing Coating Z, which is based on a PAPI polycrabamate.

It is understood that the present invention is not limited to the embodiments specifically disclosed and exemplified herein. Various modifications of the invention will be apparent to those skilled in the art. Such changes and modifications may be made without departing from the scope of the appended claims.

Moreover, each recited range includes all combinations and subcombinations of ranges, as well as specific numerals contained therein. Additionally, the disclosures of each patent, patent application, and publication cited or described in this document are hereby incorporated herein by reference, in their entireties.

1. A stripper composition, comprising:
an acidic microemulsion, comprising:
C₁₋₄ carboxylic acid;
a poorly water soluble solvent;
a salt;
a surfactant; and
water;
wherein the stripper composition comprises less than 40% of methyl benzoate, cyclic ketone, or a mixture thereof, and wherein the stripper composition is capable of removing a removable coating.

2. The composition of claim 1, wherein the stripper composition comprises less than 35%, preferably less than 30%, preferably less than 26%, of methyl benzoate, cyclic ketone, or a mixture thereof.

3. The composition of claim 1, wherein the C₁₋₄ carboxylic acid of the microemulsion is formic acid.

4. The composition of claim 3, wherein the formic acid is present in an amount from 1% to 5% of the microemulsion.

5. The composition of claim 1, wherein the poorly water soluble solvent of the microemulsion is methyl benzoate, a cyclohexanone, or a mixture thereof.

6. The composition of claim 1, wherein the stripper composition is in a single phase.

7. The composition of claim 1, wherein the stripper composition is clear.

8. The composition of claim 1, wherein the microemulsion contains no propylene glycol.

9. The composition of claim 1, wherein the microemulsion contains at least 45% water, preferably at least 49% water.

10. The composition of claim 1, wherein the microemulsion further comprises a co-solvent.

11. The composition of claim 10, wherein the microemulsion contains at least 5%, preferably at least 10%, more preferably at least 15% co-solvent.

12. The composition of claim 10, wherein the co-solvent is butyl carbitol.
